(19) United States
(12) Patent Application Publication
(10) Pub. No.: US 2007/0167202 A1
(43) Pub. Date: Jul. 19, 2007

(54) Medal display system

(76) Inventor: Francois Belzile, Blind River (CA)

Correspondence Address: MIKE GAUTHIER-DEVIAT, 355 GOODWILL DRIVE, BOX 400, GARSON, ON, P3L 1S7, US

(21) Appl. No.: 11/589,751

(22) Filed: Oct. 31, 2006

(30) Foreign Application Priority Data
Jan. 10, 2006 (CA) 2,531,784

(51) Int. Cl. A63F 13/00

(52) U.S. Cl. 463/4

(57) ABSTRACT

A modular system for the display of medals or medallions with neck ribbons or chains. The invention comprises a primary and a secondary embodiment wherein the primary embodiment depicts a tower system, and the secondary embodiment depicting and wall mount system, which both utilize the ribbon attachment methods of the present invention. Each embodiment utilizes: one or more modular boxes, which can be stacked where medals can be displayed on the outside vertical faces of each exterior box face, a top portion to enclose the upper module, and a base to provide seating and elevation of the modules. The ribbons are attached individually on the upper interior side portion of the box by means of ribbon-clamping devices, which permit easy positioning and attachment. The unused length of ribbon is concealed within the box cavity. A lighted mechanical rotating base is also described.

### FIELD OF THE INVENTION

The present invention relates to a modular system for the display of medals or medallions with neck ribbons or chains. The invention comprises a primary and a secondary embodiment wherein the primary embodiment depicts a tower system, and the secondary embodiment depicting and wall mount system, which both utilize the ribbon attachment methods of the present invention. Each embodiment utilizes: one or more modular boxes, which can be stacked where medals can be displayed on the outside vertical faces of each exterior box face, a top portion to enclose the upper module, and a base to provide seating and elevation of the modules. The ribbons are attached individually on the upper interior side portion of the box by means of ribbon-clamping devices, which permit easy positioning and attachment. The unused length of ribbon is concealed within the box cavity. A lighted mechanical rotating base is also described.

### BACKGROUND OF THE INVENTION

Achievements are often left forgotten. Children in sports are at a sensitive age where their level of self-esteem is crucial to proper intellectual development. Sporting achievements are often immortalized by the presentation of medals also referred to as medallions, yet there lacks, in the marketplace, an attractive, affordable and functional medal display system that addresses the need to properly display medals, immediately or soon after a recipient has received the award.

The inventor sought to create such a system that allows medals with neck ribbons to take their place on display surfaces, alongside trophies etc. The display system not only attractively displays the medals; it also provides space for labeling, identification, but also stores surplus, undisplayed medals, jewelries or other personal items.

At present, medals are either hung on walls, in special areas of the home.

Unfortunately, many medals end up hanging from trophies or bedposts, and often placed in drawers or stored in boxes. The traditional plaque system with slits and special attachment devices doesn't seem to be widely used. In school cabinets, the few medals displayed are whether laid flat on shelves, hang from trophies or are attached at the back of such cabinets.

Through the development of the display system of the present invention, the inventor was indeed able to provide users with an affordable, effective method of displaying such valued medals.

The applicant has retrieved several attempts in prior art that provide means of generating electrical energy using water as a source of renewable mechanical energy. Examples of such art may be had by referencing U.S. Pat. No. 6,328,171 of Coppel, U.S. Pat. No. 5,118,171 of Ortiz, and U.S. Pat. No. 6,793,297 of Johnson et al. Upon reviewing said patents, one can clearly see that these display units rely solely on either wall surfaces, or take much space. Furthermore, these patent do not allow for the easy positioning of any length of a ribbon. Additionally, none of the above patents provide lighting to further enhance the medals' presentation.

### SUMMARY OF THE INVENTION

It is thus the object of the present invention to provide users with an affordable medal display system that not only displays medal, but is easy to use and set-up, requires little surface area per medal capita, is functional and enhances the medals' presentation.

In one aspect of the invention, the tower display may be adapted with a mechanical rotary platform.

In another aspect of the invention, the tower display may be adapted with lighting implements in an attitude that illuminates the medals.

Accordingly, the device of the present invention therefore provides users with an affordable medal display system that displays medal, is easy to use and set-up, requires little surface area, is functional and enhances the medals' presentation.

The utility of the present invention includes but is not limited to medals.

### BRIEF DESCRIPTION OF THE DRAWINGS

These and other advantages of the invention will become apparent upon reading the following brief description and upon referring to the drawings in which:

FIG. 1 is a perspective view from above of the tower embodiment of the medal display system present invention shown with one module.

FIG. 2 is a perspective view from above of the tower embodiment of the medal display system of the present shown with three modules.

FIG. 3 is a perspective view from above of a module of the tower embodiment of the medal display system of the present invention.

FIG. 4 is a partial cross-sectional view of two modules of the medal display system of the present invention.

FIG. 5 is a perspective view from above of the top module of the tower embodiment of the medal display system of the present invention.

FIG. 6 is a partial front elevation view of the medal display system of the present invention.

FIGS. 7, 8 and 9 are cross-sectional views taken along lines 7, 8, 9 of FIG. 1 of the medal display system of the present invention.

FIG. 10 is a front elevation view of the base portion of the tower embodiment of the present invention.

FIG. 11 is a perspective view from above of the wall-mount embodiment of the medal display system of the present invention.

FIG. 12 is a left side elevation view of the wall-mount embodiment of the medal display system of the present invention.

FIG. 13 is a partial perspective view from above of the wall-mount embodiment of the medal display system of the present invention.

While the invention is described in conjunction with preferred illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

Turning to FIGS. 1 and 2, both illustrating the tower embodiment of the medal display of the present invention shown with one and three modules respectively, comprising: a base unit 2 having outer dimensions substantially greater than those of a tower assembly 4, a tower base adapter 6 rotably mounted to the upper surface of the base unit 2, a plurality of lights 8 imbedded within the upper surface of the base unit 2, and a power supply connector at the rear of the unit, a tower assembly 4 further comprising: a tower base 10 adapted to matingly engage within a raised perimeter portion 7 of the tower base adapter 6, medal modules 12 having downwardly protruding pins 14 at each lower corner adapted to engage within holes 16 atop each medal module 12 and tower base 10, ribbon clamps 20 inside each wall of the display modules 12, a tower top 18 having downwardly protruding pins 14 at each lower corner adapted to engage within holes 16 atop each medal module 12, and card holders 19 integral with each outer side surface of the tower top 18.

Turning now to FIGS. 3 and 6, FIG. 3, a perspective view from above of a display module 12, and FIG. 6 a partial front elevation view of the tower embodiment of the present invention where it can be seen that two each depressions at the upper edge of each wall of the display module 12, which said depressions form ribbon guides 22 serving two purposes; to space the ribbons 25 at the correct span, and to enable the modules 12 to mate together.

In FIG. 3, one can also better visualize the ribbon clamp 20 arrangement; in that, these clamps 20 are integrally molded with each inside surfaces of each display module 12 thereby enabling production of said modules without post molding assembly. Furthermore, the clamps 20 are so arranged to allow the passage of ribbons therebehind for ribbon comfort and ease of handling of said ribbons.

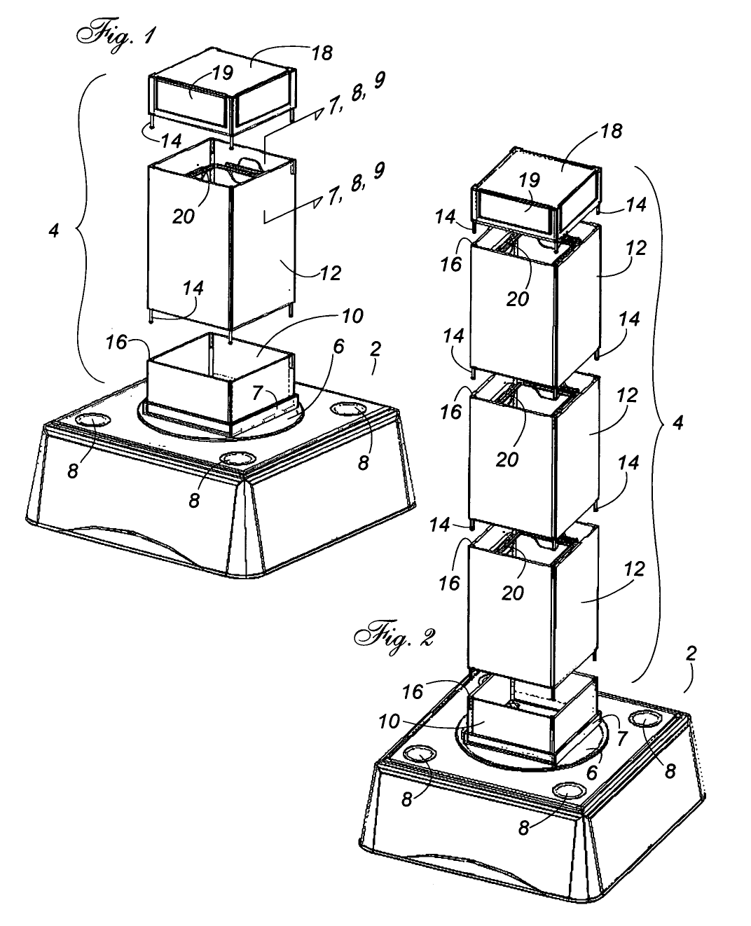

Turning to FIG. 4, a partial cross-sectional view of two modules 12 showing the interconnection between said modules 12 wherein downwardly protruding pins 14 at each lower corner are adapted to engage within equally spaced holes 16 atop each module 12. This provides a stable assembly of the various components that make up the tower assembly.

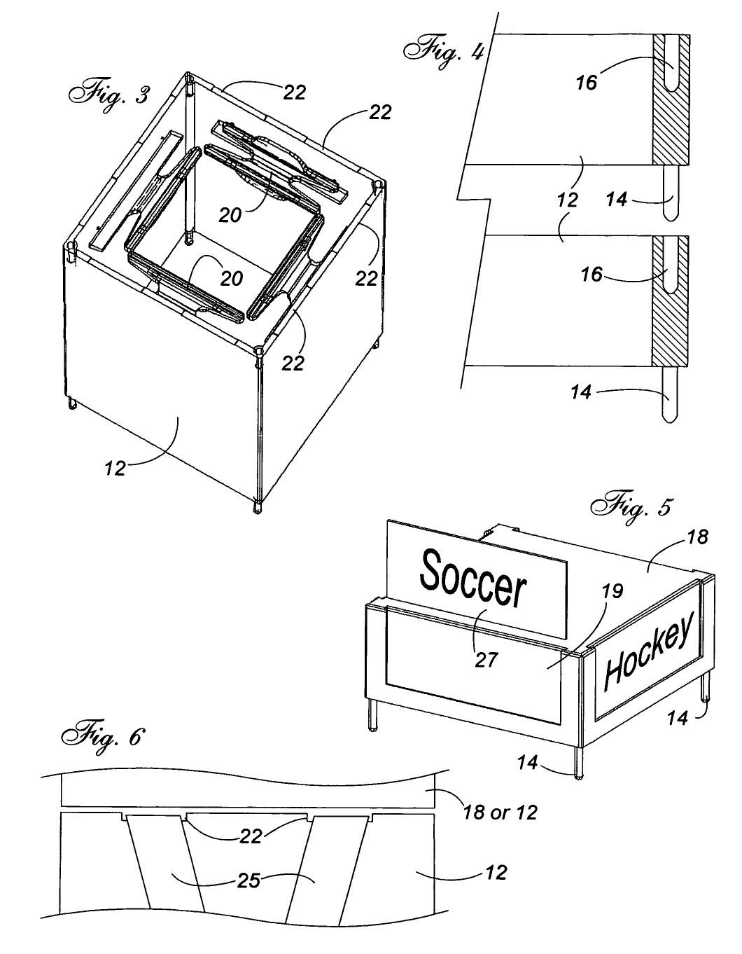

Turning to FIG. 5, a perspective view from above of the tower top 18 wherein said top 18 incorporates downwardly protruding pins 14 at each lower corner adapted to engage within holes atop each medal module, and card holders 19 integral with each outer side surface of the tower top 18. Said card holders 19 comprise a recess into the surface of each wall and a retainer rim to hold cards 27 into said card holder 19. A user can now categorize medals as necessary.

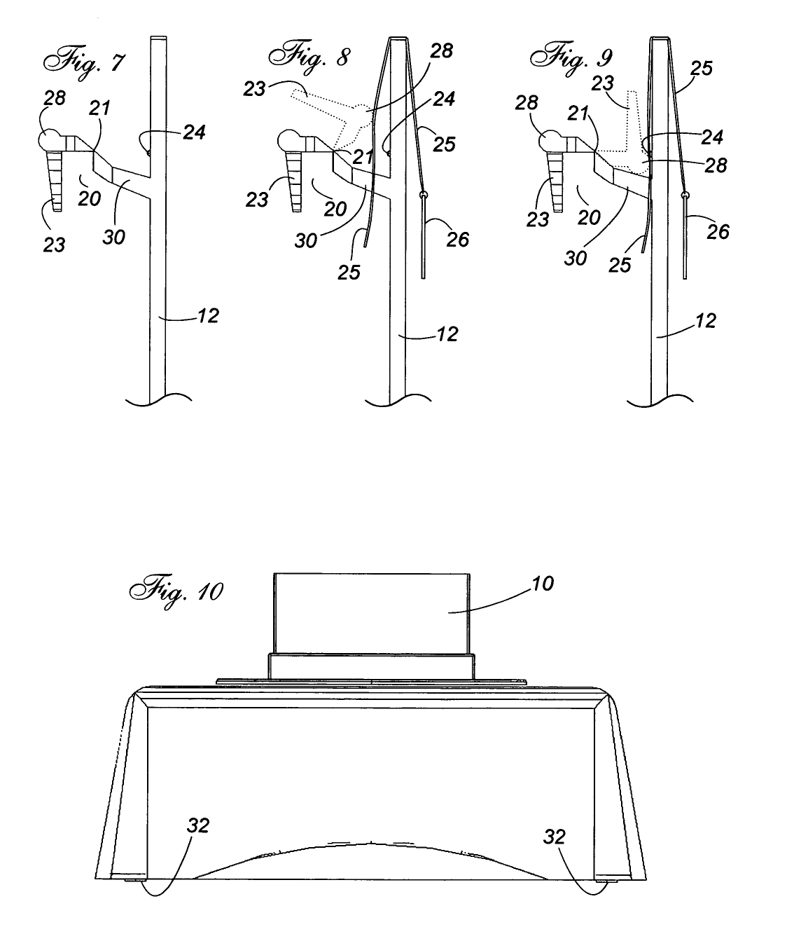

Referring now to FIGS. 7, 8 and 9, all cross-sectional views of the ribbon clamp 20 portion of the display module 12 wherein each ribbon clamp 20 comprises: an extension 30, a molded hinge 21, a handle 23, and a latch 28. Rotating the handle 23 upwardly and outwardly allows the latch 28 to press each ribbon 25 simultaneously against two snap nipples 24 and the inner wall surface of the module 12 thus providing an anti-slip ribbon 25 attachment to the module 12 thus positioning medal 26 on outside vertical face of said module 12.

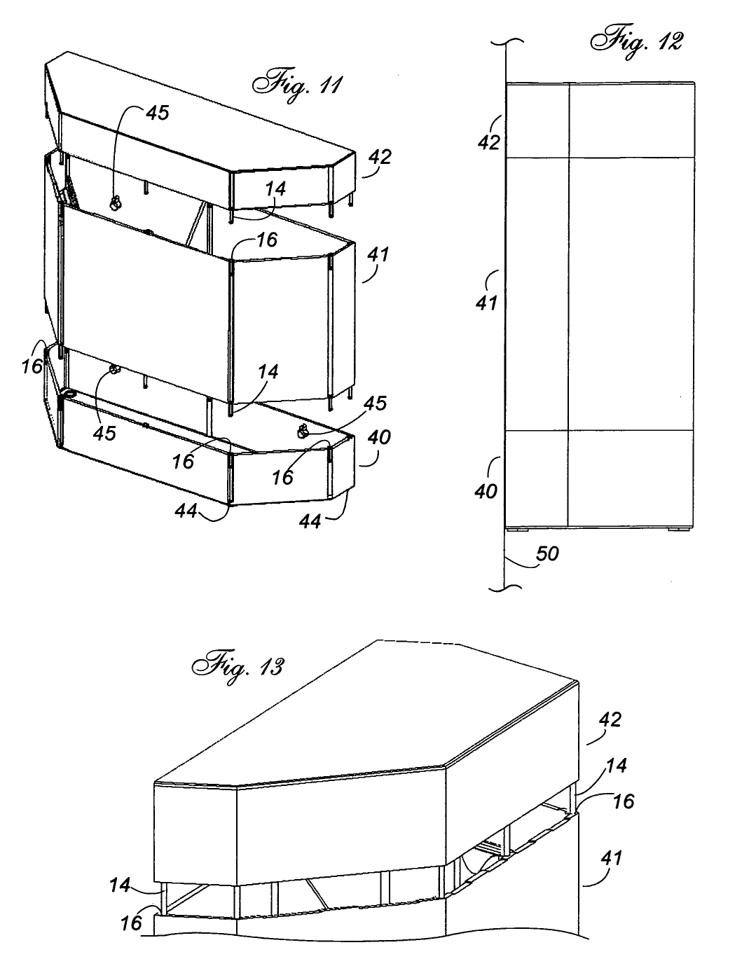

Turning now to FIG. 10, a front elevation view of the base portion of the tower embodiment of the present invention wherein the base unit 2 is further adapted with anti-slip feet 32 so as to frictionally grip to the surface on which it rests without movement. It can be noted that the base unit 2 may be adapted with manual or even mechanical rotary motion of the tower base adapter 6 so as to further enhance the display effectiveness.

Referring now to FIGS. 11, 12 and 13, a secondary embodiment of the medal display system of the present invention wherein this embodiment provides all the ribbon management benefits of the primary tower embodiment but applies such benefits to a wall-mountable modular display. In addition to these ribbon management benefits this embodiment then further comprises:

a bottom closure 40 having: a planar base, a continuous raised perimeter forming a front, sides and a back, pin receiving holes at two or more top corners, anti-slip feet 44, and mounting holes 45,

a wall display module 41 having: a perimeter wall of similar footprint to that of the bottom closure 40, forming a front, sides and a back, pin receiving holes 16 at two or more top corners or each module, downwardly protruding pins 14 at mating corners to those of the pin receiving holes 16, and wall mounting holes 45, and

a top module 42 having a planar cover with downwardly extending walls forming a front, sides and a back, and downwardly protruding pins 14 at mating corners to those of the pin receiving holes 16 of the wall display modules 41.

Therefore, it can now be understood how the tower and wall embodiments of the present invention provide the benefits of medal display capabilities in such a manner that enables; ease of set-up, ease of medal placement, affordability, effective display prominence, and modular assembly as desired. Each display module allows for the deployment of a plurality of medals at any desired length of ribbon exposure. The number of modules and their faces used for medal display depend on user preference. The shortest vertical assembly generally comprise of three modules: a base module, a display module and the top module. User can stack as many display modules as so desired. The display modules can take different shapes, such as rectangular, circular or elliptical etc.

The placing of medals may be effected on a flat surface such as a table or desk. The use of a medal support can used to position the medal at the right height and to temporarily immobilize it during the straightening of the ribbon. The support is composed of an enlarged base, overhung by two risings covered with spongy material between which the medal is inserted.

A first display box is inserted on its base and the medal support is placed directly in front. The medal is slid into the support, the ribbon is pulled over the ribbon guides in order to insert a ribbon clamp over the two strands of ribbon and against the inside edge. Surplus ribbon is placed inside the box cavity, hidden from sight. With the ribbon attached, the medal is now removed from its support. The procedure is repeated for the other sides of the box. To space out the medals and expose a longer length of ribbon, one can choose a deployment of ribbon over two or more module instead of a single unit. Every box is then decorated and assembled one atop another. Four stacked modules will form generally a safe vertical structure as long as the support base or the rotating system has an enlarged base.

Medal display on modules and the assembling of these modules permits a preferred design. This method surpasses prior art, which places medals on a plaque with a predetermined global size of display.

The deployment system for the ribbon and its attachment on the interior upper part of a module offers ample space to ensure quick and efficient handling; contrary to traditional models where the ribbon had to be inserted inside a slit in order to dissimulate it in a more restricted space behind a plaque.

The cavity of the module is sufficiently large to accept the unused lengths of ribbon, without having to roll or manipulate the ribbon further.

The module deployment system permits the desired spacing of medals and the required display length of ribbon.

Newly awarded medals can be later displayed by utilizing new display modules, added to existing assemblies.

A futuristic realisation of the box deployment system is the edification of a display tower which can be animated rotary motion.

An optional feature may permit the ribbon to enter the module diagonally. The user can create a variety of styles of display. Wall and/or corner display modules may be assembled, forming a variety of home, school or work based products. Every display structure provides ample space for event announcement or for sponsor's advertisement.

What I claim as my Invention:

1. A medal display system comprising:
a. a tower embodiment comprising, a base unit having outer dimensions substantially greater than those of a tower assembly, a tower base adapter rotably mounted to the upper surface of the base unit, a plurality of lights imbedded within the upper surface of the base unit, and a power supply connector at the rear of the unit, a tower assembly further comprising: a tower base adapted to matingly engage within a raised perimeter portion of the tower base adapter, medal modules having downwardly protruding pins at each lower corner adapted to engage within holes atop each medal module and tower base, ribbon clamps inside each wall of the display modules, a tower top having downwardly protruding pins at each lower corner adapted to engage within holes atop each medal module, and card holders integral with each outer side surface of the tower top, and
b. a wall-mounted embodiment comprising: a bottom closure having: a planar base, a continuous raised perimeter forming a front, sides and a back, pin receiving holes at two or more top corners, anti-slip feet, and mounting holes, a wall display module having: a perimeter wall of similar footprint to that of the bottom closure, forming a front, sides and a back, forming a front, sides and a back, pin receiving holes at two or more top corners of each module, downwardly protruding pins at mating corners to those of the pin receiving holes, a plurality of ribbon clamps integral with the inner wall faces of the display modules, and wall mounting holes, and a top module having a planar cover with downwardly extending walls forming a front, sides and a back, and downwardly protruding pins at mating corners to those of the pin receiving holes of the wall display modules.

2. The medal display system of claim 1 wherein the tower modules are such that pins at the bottom corners mate alignedly with pin receiving holes atop a lower module.

3. The medal display system of claim 1 wherein the tower base has bottom dimensions slightly lesser than those of a tower base adapter and that the tower base rests fittingly within raised walls atop the tower base adapter.

4. The medal display system of claim 1 wherein the tower base lighting comprises: a recessed conical form within the base unit, a bulb-receiving opening at the very lower portion of the cone, and a clear cover over said lighting.

5. The medal display system of claim 4 wherein the conical forms are directed toward the central area above the base unit.

6. The medal display system of claim 1 wherein the ribbon clamp comprises: an extension protruding inwardly so as to extend a hinge slightly distally from the inner wall surface of a module, a hinge molded integrally with the extension, a grip handle, and a latch.

7. The medal display system of claim 6 wherein when ribbon is placed along the inner wall surface between the ribbon clamp, rotating the handle upwardly and outwardly allows the latch of the clamp to press a ribbon simultaneously against two snap nipples and the inner wall surface of the module.

8. The medal display system of claim 1 wherein the system is modular thus allowing the insertion of one or more display modules without limitation.

9. The medal display system of claim 1 wherein the modules are hollow so as to provide ample space for excess ribbon collection.

10. The medal display system of claim 1 wherein the tower base adapter is rotably engaged with the base unit.

11. The medal display system of claim 10 wherein the tower base adapter is mechanically rotable.

12. The medal display system of claim 1 wherein the modules include ribbon guides comprising two sunken areas at the top edge of each display face so as to allow for the ribbon's thickness between modules.

13. The medal display system of claim 1 wherein the tower top module comprises: downwardly protruding pins at each lower corner adapted to engage within holes atop each medal module, and card holders integral with each outer side surface of the tower top, which said card holders comprise a recess into the surface of each wall and a retainer rim to hold cards into said card holder so as to allow user to categorize medals as so desired.

14. The medal display system of either claim 1 through 13 wherein the utility thereof is to provide users with an affordable, customizable, effective and attractive system for displaying one's achievements in areas where it is customary to receive medals and medallions.
